(19) United States
(12) Patent Application Publication
(10) Pub. No.: US 2004/0019126 A1
(43) Pub. Date: Jan. 29, 2004

(54) Use of antioxidants in radiation-curable coating compositions for producing abhesive coatings

(76) Inventors: Mike Brand, Essen (DE); Hardi Dohler, Hattingen (DE); Winfried Hamann, Essen (DE); Jurgen Pomorin, Essen (DE)

Correspondence Address: FROMMER LAWRENCE & HAUG LLP, 745 Fifth Avenue, New York, NY, 10151, US

(21) Appl. No.: 10/621,237

(22) Filed: Jul. 16, 2003

(30) Foreign Application Priority Data
Jul. 19, 2002 (DE) 102 32 828.5

(51) Int. Cl. C08F 2/46

(52) U.S. Cl. 521/49; 521/99

(57) ABSTRACT

The present invention provides radiation-curable coating compositions for producing abhesive coatings, comprising at least one radiation-curing organopolysiloxane having (meth)acrylate ester groups, an additive to compensate the inhibition caused by oxygen in the course of curing, and, if desired, photoinitiators and customary auxiliaries and adjuvants, wherein said additive used is at least one antioxidant from the group of the phosphorus(III) compounds and/or sulfur compounds.

### RELATED APPLICATIONS

The application claims priority under 35 USC §119 to German application 102 32 828.5, filed Jul. 19,.2002, herein incorporated by reference.

### BACKROUND OF THE INVENTIONS

1. Field of the Invention

The invention relates to radiation-curable coating compositions comprising at least one radiation-curing organopolysiloxane having (meth)acrylic ester groups, in which antioxidants are used to compensate the inhibition caused by oxygen in the course of curing, and to their use for producing abhesive coatings.

2. Description of the Related Art

Abhesive coating compositions are used extensively for the coating in particular of web materials in order to reduce the propensity of adhesive products to adhere to these surfaces.

Abhesive coating compositions are used, for example, to coat papers or films intended for use as backings for self-adhesive labels. The labels, provided with a pressure-sensitive adhesive, still adhere to the coated surface to a sufficient extent to allow the backing films bearing the adhesive labels to be handled. The adhesion of the adhesive labels to the backing films must be sufficiently high that in the course of mechanical application of labels, to bottles for example, the labels do not become detached prematurely from their backing films as they run over deflection rollers. On the other hand, however, the labels must be able to be peeled from the coated backing film without any substantial impairment in their bond strength for the subsequent utility. Further possibilities for application of abhesive coating compositions are packaging papers, which are used in particular to package sticky goods. Abhesive papers or films of this kind are used, for example, to package food stuffs or to package industrial products, such as bitumen, for example.

A further application of abhesive coating compositions is in the production of self-stick closures, as, for example, in the case of disposable diapers. If the abhesiveness is too high, i.e., the release force too low, the diaper does not stay reliably closed. If the abhesiveness is too low and thus the release force too high the closure can no longer be opened without destructive tearing of the diaper.

The preparation of organosiloxanes with (meth)acrylate-modified organic groups attached to the siloxane unit by way of Si—O and/or Si—C bonds is described in numerous patents. The prior art is represented by the following patents.

Organopolysiloxanes where the (meth)acrylate containing organic groups are connected to the polysiloxane framework by way of Si—O—C bond are described in DE-C-27 47233 and DE-C-29 48 708.

Organopolysiloxanes in which the acrylate-containing organic groups are connected to the polysiloxane framework by way of Si—C bonds can be prepared, for example, by subjecting a hydrosiloxane to addition reaction with allyl glycidyl ether or another suitable epoxide having an olefinic double bond and, following the addition reaction, esterifying the epoxide with acrylic acid, in the course of which the epoxide ring is opened. This procedure is described in DE-C-38 20 294.

A further possibility for preparing (meth)acrylate-modified polysiloxanes with Si—C linkage of the modifying group(s) is to subject a hydrosiloxane to addition reaction with an alcohol having a olefinic double bond, such as alkyl alcohol, in the presence of a platinum catalyst and then to react the OH group of said alcohol with acrylic acid or a with a mixture of acrylic acid and other saturated or unsaturated acids. This procedure is described, for example, in DE-C-38 10 140.

A further possibility is in each case to attach two or more (meth)acrylate groups per connecting link to the siloxane framework. In order to achieve optimum crosslinking—that is, as high as possible a number of reactive groups in conjunction with as small as possible a density of modification on the siloxane backbone—it is desirable to attach more than one (meth)acrylate group per bridging link. Such processes are described, for example, in U.S. Pat. No. 6,211,322.

Examples of the organosilicon compounds mentioned are available, for example, from Goldschmidt, Germany, under the product name TEGO® RC, from Shin Etsu, Japan under the name X-8010, and from Rhodia, France under the designation UV Poly 100 and RCA 110.

A feature common to all of organosilicon compounds mentioned is that by UV radiation (following the addition of known photoinitiators) or by electron beams (EB) they cure in a very short time in a free-radical polymerization reaction. An overview of suitable photoinitiators, although not constituting any restriction, is given in J. P. Fouassier, Polymerization Photoinitiators: Excited State Process and Kinetic Aspects, Progress in Organic Coating, 18 (1990), 229-252 and in EP-A-1 072 326.

To prepare the stated coating materials it is normal to apply the curable mixtures to web substrates of plastic, metal or paper and to pass the substrates in web form from roll to roll at high machine speeds of several hundred meters per minute through an UV or EB unit, where curing takes place.

Free-radical addition polymerization is subject to a constricting oxygen inhibition. This constriction is all the greater the smaller the amount of double bonds that are capable of polymerization. The degree of modification is not one which can be chosen arbitrarily, since a high concentration of polymerization-capable double bonds has an effect on the release properties. The organosilicon compounds described, which have particularly good abhesive properties, normally contain a very small fraction of polymerization-capable double bonds.

In U. Müller, New Insights in the Influence of Oxygen on the Photocrosslinking of Silicone Acrylates, Organosilicon Chem. IV, 4th (2000), Meeting Date 1998, 663-666, Wiley-VCH Verlag GmbH, Weinheim, Germany it is shown that during the UV curing of TEGO® RC silicones from Goldschmidt in thin films below 100 μm in air no acrylate double bonds are consumed, i.e., no curing ensues, since all the initiator radicals are intercepted by oxygen.

In contrast to the stated organosilicon compounds, a large number of purely organic compounds are known which contain double bonds capable of free-radical polymerization and which cure by UV radiation (following the addition of known photoinitiators, such as benzophenone and its derivatives, for example) or by electron beams. A feature normally common to these organic UV-curing coating compositions is that in comparison to the stated organosilicon compounds they include a higher fraction of polymerization-capable double bonds. These coating compositions are used, for example, for printing inns and for producing film-forming binders or for the coating of paper, plastics, wood, and metal surfaces, but without a high-grade abhesive quality. The coating fulfills its intended use if it cures, for example, without smearing, with sufficient surface hardness and gloss. The amount of polymerization-capable double bonds can therefore be chosen more variably, and in the majority of cases is much higher.

In contrast to the stated organosilicon compounds the stated organic compounds are significantly less sensitive to oxygen inhibition, owing to the higher fraction of polymerization-capable double bonds. By increasing the intensity of UV irradiation or the photoinitiator concentration it is possible to achieve a further reduction in the oxygen sensitivity. The coating material is therefore frequently curable in normal air.

Increasing the intensity of UV irradiation or the photoinitiator concentration does not lead to high-quality release coatings when the organosilicon compounds described are cured in air or when there are high residual oxygen concentrations. An excessive residual oxygen concentration has an adverse effect on the release properties of the cured coating. The degree of cross linking of the coating composition decreases as the residual oxygen content goes up. Uncrosslinked organosilicon compounds remain in the coating. The release coating reacts with constituents of adhesive substances, leading to a change in the release effect with respect to the adhesive substance. There may in particular be an adverse effect on the stability of the release force over relatively long periods of time.

It has therefore proven to be necessary to blanket the coating at the time of curing with pure nitrogen. The reaction chamber of the UV or EB unit is flushed with high-purity nitrogen, and atmospheric oxygen is displaced down to a residual concentration of preferably less than 50 ppm. The use of nitrogen, however, represents an additional cost.

The literature depicts a variety of possibilities for the chemical compensation of oxygen inhibition:

1. K. K Dietliker, Chemistry & Technology of UV & EB Formulation for Coatings, Inks & Paints, Volume 3, Sita Technology Ltd, UK, p. 83 describes the addition of amines, especially tertiary amines.

2. C. Decker, A Novel Method for Consuming Oxygen Instantaneously in Photopolymerizable Films, Macromol. Chem. 180, 2027-2030 (1979) describes the infrared-induced excitation of oxygen to the singlet state by means of methylene blue, for example, and subsequent oxidation of 1,3-diphenylisobenzofuran as a scavenging reaction for free oxygen.

3. C. W. Miller et al., Analysis of the reduction of oxygen inhibition by N-Vinylimides in free radical photocuring of acrylic formulations, RadTech 2000, Technical proceedings describe the positive effect of N-vinylimides on the UV curing of organic coating compositions under air.

4. B. Xiao et al., Studies on curing effects of phosphite monomer by EB radiation in the air, Radiation Physics and Chemistry 57 (2000) 421-424 describe the synthesis of an acrylate-functional phosphite and its use in organic acrylate coating compositions in the context of EB curing in air.

5. C. R Mogan et al., UV generated oxygen scavengers and their effectiveness in photopolymerizable systems, Journal of Radiation Curing, October 1983 investigate the effect of amines, thiols, and phosphorus compounds on the reduction in the amount of oxygen dissolved in organic UV-curing coating compositions.

6. E. Zadok, Optimisation of the photocuring of a ternary mixture of methacrylic monomers using DSC, Thermal analysis highlights, 9^{th} ICTA, Jerusalem, Israel, 21-25 August 1988 describes the use of differential scanning calorimetry to investigate the UV curing of organic coating materials and phosphites.

7. U.S. Pat. No. 3,699,022 describes the use of organic UV-curing coating materials based on unsaturated polyesters with a mixture of benzoin ether photoinitiators, phosphines and phosphites.

The effectiveness of the reaction principles is described in (2, 5, 6) for laboratory systems. No predictions are made of their suitability in high-speed production plants in application as a thin film to web substrates. None of the methods stated, with the exception of the use of especially tertiary amines (1), has become established in the art, nor is any reflected in standard formulations and applications of UV- or EB-curing coating compositions or release coatings. In the curing of the organosilicon compounds described, however, the effectiveness of tertiary amines is not sufficient to produce a significant increase in the allowable amount of residual oxygen without leading increasingly to low-quality release coatings.

The thiol and phosphorus compounds from references (4-7) are normally used as antioxidants in plastics and coatings in order to improve the durability and the weathering stability and UV stability. They have not acquired any technical relevance in alleviating oxygen inhibition in organic UV- or EB-curing coating compositions.

### SUMMARY OF THE INVENTION

Surprisingly it has been found that through the use of such antioxidants the adverse effect of atmospheric oxygen on the curing of the stated organosiloxanyl (meth)acrylates which can be cured under UV light or by means of electron beams is effectively suppressed. Tolerance to the residual oxygen content in the reaction chamber is significantly increased and the quality of the resultant release coating toward adhesive substances are improved.

### DESCRIPTION OF THE INVENTION

The present invention accordingly provides in one of its aspects a radiation-curable coating composition which comprises at least one radiation-curing organopolysiloxane having (meth)arcylate ester groups, an additive to compensate the inhibition caused by oxygen in the course of curing, and, if desired, photoinitiators and customary auxiliaries and adjuvants, wherein said additive used is at least one antioxidant from the group of the phosphorus(III) compounds and/or sulfur compounds.

Further subject matter of the invention is defined by the claims.

The antioxidants which can be used in accordance with the invention are those which are normally used to stabilize properties such as storabilty, heat resistance, weathering stability, and UV stability in polymer coatings and polymer moldings. The compounds, which in some cases here are also referred to stabilizers, are included under the inventive definition of the antioxidants. Antioxidants of the invention are those from the group of the peroxide-destroying antioxidants, particularly those with phosphorus(III) compounds and sulfur antioxidants:

Phosphorus(III) compounds are antioxidants of the general formula

(R)_{b}—P—(OR)ₐ

in which the radicals

R are identical or different and are aliphatic, cycloaliphatic, aromatic, araliphatic or heterocyclic radicals and

a and b can be from 0 to 3, where a+b must be 3 and, preferably, at least one of the radicals is —OR; examples include

Triphenyl phosphite, diphenyl isodecyl phosphite, diphenyl isooctyl phosphite, phenyl diiso-decyl phosphite, triisodecyl phosphite, triisobutyl phosphite, tris(2-ethylhexyl) phosphite, tris-(tridecyl) phosphite, trilauryl phosphite, 4,4′-butylidene-bis(3-methyl-6-t-butylphenylditridecyl) phosphite, neopentanetetrayl bis(octadecyl) phosphite, tris(nonylphenyl) phosphite, tris(mono- and/or dinonylphenyl) phosphite, diisodecyl pentaerythritol diphosphite, tetraphenyl dipropylene glycol diphosphite, poly(dipropylene glycol) phenyl phosphite, alkyl (C₁₀ to C₁₅) bisphenol A phosphite, tris(dipropylene glycol) phosphite, dioleyl hydrogen phosphite, 9,10-dihydro-9-oxa-10-phosphaphenanthrene 10-oxide, 10-(3,5-di-t-butyl)4-hydroxybenzyl-9,10-dihydro-9-oxa-10-phosphaphenanthrene 10-oxide, 10-decyloxy-9,10-dihydro-9-oxa-10-phosphaphenanthrene, tris(2,4-di-t-butylphenyl) phosphite, cyclic neopentanetetrayl bis(2,4-di-t-butylphenyl) phosphite, cyclic neopentanetetrayl bis(2,6-di-t-butyl-4-methylphenyl) phosphite; 2,2-methylenebis(4,6-di-t-butylphenyl)octyl phosphite, distearyl pentaerythritol diphosphite, di(2,4-di-t-butylphenyl) phosphite, tetrakis(2,4-di-t-butylphenyl)-4,4-biphenylene diphosphonite, bis(2-ethylhexyl) 2-ethylhexylphosphonate, dibutyl butyl phosphonate, triisooctylphosphine, triphenylphosphine, and phenyl-diisooctylphosphine; and also

sulfur antioxidants, such as dilauryl 3,3′-thiodipropionate, dimyristyl 3,3′-thiodipropionate, distearyl 3,3′-thiodipropionate, 2-mercaptobenzimidazole, n-dodecylthiol, tetrakismethylene-3-(laurylthio)propionatomethane, stearylthiopropylamide, distearyl disulfide, 3,3-thio-di-(propionic acid lauryl ester), 3,3-thio-di(propionic acid stearyl ester), di-octadecyl disulfide, thiodiethylene bis[3-(3,5-di-tert-butyl-4-hydroxyphenyl)propionate], 4,6-bis(octylthiomethyl)-o-cresol, 4,4′-thiobis(2-t-butyl-5-methylphenol), 4,4′-thiobis(6-t-butyl-5-methylphenol), metal salts, for example the zinc salt of dialkyldithiocarbamic acid, and zinc dialkyldithiophosphates such as zinc di(4-methylpentyl)-2-dithiophosphonate.

These types of antioxidant can be used alone or in each case in combination with one another or in combinations between each other. Based on the stated organically modified polysiloxanes the antioxidants are used in an amount of from about 0.00001 to about 20% by weight, in particular from about 0.005 to about 5% by weight.

The process for admixing the antioxidants to the stated organically modified polysiloxanes is not subject to any particular restriction. It is preferred to use antioxidants which are in meltable (m.p.<ca. 80° C.) or liquid form. Particularly suitable antioxidants are those are which compatible with and miscible in the silicone matrix.

Advantages of the UV or EB crosslinking of an inventive mixture of antioxidants and/or stabilizers and the stated organically modified polysiloxanes include the following:

The allowable residual oxygen content during UV-induced polymerization is significantly increased.

The curing of the products on substrate material is possible at increased speeds.

It is possible to save on pure nitrogen, as is required to achieve very low residual oxygen concentrations in the reaction chamber, and to use less pure nitrogen for inertization.

The mechanical complexity required to achieve the now increased residual oxygen concentration is simplified, along with an increase in production safety.

The release coatings obtained possess an improved profile of properties.

There is less of a variation, or none at all, in the abhesiveness of the cured products on storage, recognizable from the increase in release force.

The curable mixtures of the invention comprising antioxidants and the stated organically modified polysiloxanes and photoinitiators, can be used as radiation-curing paints or coating compositions or as additives to such systems.

They can be compounded conventionally with curing initiators, fillers, pigments, other conventional acrylate systems and further customary adjuvants. They can be crosslinked three dimensionally by means of free radicals and cure under the influence of high-energy radiation such as UV or electron beams within a very short time to form mechanically and chemically resistant coats. Where the radiation source used is UV light, crosslinking takes place preferably in the presence of photoinitiators and/or photosensitizers such as benzophenone and its derivatives or benzoin and corresponding substituted benzoin derivatives, for example.

Photoinitiators and/or photosensitizers are used in the compositions comprising the organopolysiloxanes preferably in amounts of from about 0.01 to about 10% by weight, in particular from about 0.1 to about 5% by weight, based in each case on the weight of the acrylate-functional organopolysiloxanes.

The examples below are intended to illustrate the invention, but do not constitute any restriction whatsoever.

### EXAMPLES

Performance Testing:

To test the performance properties of the substances for use in accordance with the invention the products of the examples and those of the non-inventive, comparative examples, following the addition of 2% of photoinitiator (Darocur® 1173, Ciba Spezialitäten Chemie), are applied to web substrates (orientated polypropylene film) and are cured by exposure to UV light from a medium-pressure mercury vapor lamp at 120 W/cm under nitrogen inertization with different residual oxygen contents and at different web speeds. The application rate is in each case approximately 1 g/m².

Release Force:

The release force is determined using different adhesive tapes 25 mm wide, namely an adhesive tape coated with acrylate adhesive and obtainable commercially from Beiersdorf under the name TESA® 7475 and also an adhesive tape coated with an industry-standard hotmelt pressure-sensitive adhesive based on styrene—isoprene-styrene block copolymer (SIS), styrene-butadiene rubber (SBR), and rosin tackifier.

To measure the abhesiveness these adhesive tapes are rolled onto the substrate and then stored at 40° C. under a weight of 70 g/cm². After 24 hours a measurement is made of the force required to remove the respective adhesive tape from the substrate at a speed of 30 cm/min and a peel angle of 180°. This force is termed the release force. The general test procedure corresponds essentially to test method No. 10 of the Fédération Internationale des Fabricants et Transformateurs D'Adhésifs et Thermocollants sur Papier et autres Supports (FINAT). In order to investigate the aging behavior the storage time is extended to 3 months under the conditions described above. Blocking is said to occur if the abhesive effect of the release coating is reduced to such an extent by aging that the adhesive tape can no longer be detached, or can be detached only by applying a very high force.

Loop Test:

The loop test serves for rapid determination of the degree of cure of a release coating. For this test a strip of the adhesive tape TESA® 4154 from Beiersdorf approximately 20 cm long is rolled three times on to the substrate and immediately removed again by hand. Then, by placing the ends of the adhesive tape together, a loop is formed, so that the adhesive faces of both ends are in contact over a distance of approximately one centimeter. The ends are then pulled apart again by hand, in the course of which the contact area ought to migrate uniformly to the center of the adhesive tape. In the case of contamination with poorly cured release material the bond strength of the adhesive tape is no longer sufficient to hold the contact area together when the ends are pulled apart. In this case the test is classed as failed.

Subsequent Adhesion:

The subsequent adhesion is determined very largely in accordance with FINAT test specification No. 11. For this purpose the adhesive tape TESA® 7475 from Beiersdorf is rolled on to the substrate and then stored at 40° C. under a weight of 70 g/cm². After 24 hours the adhesive tape is separated from the release substrate and rolled on to a defined substrate (steel plate, glass plate, film). After one minute a measurement is made of the force required to remove the adhesive tape from the substrate at a speed of 30 cm/min and a peel angle of 180°. The resulting measurement is divided by the value for the same measurement on an untreated adhesive tape under otherwise identical test conditions. The result is termed the subsequent adhesion and is expressed in general as a percentage. Figures above 80% are considered by the skilled worker to be sufficient, and suggest effective curing.

Radiation-Curing Organosilicon Compounds:

The radiation-curing organosilicon compounds used are products of the company Goldschmidt, which are obtainable under the designation TEGO® RC. The product TEGO® RC 902 has a very good abhesive effect toward adhesive substances in the cured coating. The amount of polymerization-capable double bonds is very low. TEGO® RC 902 is blended with TEGO® RC 711 in order to improve the substrate adhesion. TEGO® RC 711 has a higher amount of polymerization-capable double bonds and consequently, if coated on its own, also has a lower abhesiveness toward adhesive substances in the cured coating.

Test Series I:

| | | | Web | Residual | |
|---|---|---|---|---|---|
| Example | | | speed | oxygen on | |
| UV curing | TEGO ® RC product | Antioxidant | m/min | UV curing | |
| 1 | RC 902/RC 711 | none | 20 | 20 | ppm |
| | 70:30 | | | | |
| 2 | RC 902/RC 711 | none | 20 | 200 | ppm |
| | 70:30 | | | | |
| 3 | RC 902/RC 711 | none | 20 | 500 | ppm |
| | 70:30 | | | | |
| 4 | RC 902/RC 711 | 1% triphenyl phosphite | 20 | 20 | ppm |
| | 70:30 | | | | |
| 5 | RC 902/RC 711 | 1% triphenyl phosphite | 20 | 200 | ppm |
| | 70:30 | | | | |
| 6 | RC 902/RC 711 | 1% triphenyl phosphite | 20 | 500 | ppm |
| | 70:30 | | | | |

| | | | | Release force | Release force |
|---|---|---|---|---|---|
| | | | Release force | after 24 hours | after 3 months |
| | | Subsequent | after 24 hours | hotmelt | hotmelt |
| | | adhesion | TESA ® 7475 | adhesive tape | adhesive tape |
| Example | Loop test^{*)} | % | cN/2.5 cm | cN/2.5 cm | cN/2.5 cm |
| 1 | sat. | 90 | 7 | 45 | 46 |
| 2 | sat. | 80 | 7 | 48 | 70 |
| 3 | not sat. | 40 | 5 | 40 | 180 |
| 4 | sat. | 90 | 7 | 45 | 48 |
| 5 | sat. | 90 | 7 | 46 | 43 |
| 6 | sat. | 80 | 7 | 50 | 46 |

^{*)}sat. = satisfactory

Performance Testing of Test Series I:

Test series II:

| | | | Web | Residual | |
|---|---|---|---|---|---|
| Example | TEGO ® | | speed | oxygen on | |
| UV curing | RC product | Antioxidant | m/min | UV curing | |
| 7 | RC 711 | none | 20 | 20 | ppm |
| 8 | RC 711 | none | 20 | 500 | ppm |
| 9 | RC 711 | none | 20 | 1500 | ppm |
| 10 | RC 711 | 1% triphenyl phosphite | 20 | 20 | ppm |
| 11 | RC 711 | 1% triphenyl phosphite | 20 | 500 | ppm |
| 12 | RC 711 | 1% triphenyl phosphite | 20 | 1500 | ppm |

Performance testing of test series II:

| | | | | Release | |
|---|---|---|---|---|---|
| | | | | force | Release force |
| | | | Release force | after 24 hours | after 3 months |
| | | Subsequent | after 24 hours | hotmelt | hotmelt |
| | Loop | adhesion | TESA ® 7475 | adhesive tape | adhesive tape |
| Example | test*) | % | cN/2.5 cm | cN/2.5 cm | cN/2.5 cm |
| 7 | sat. | 90 | 354 | 220 | 213 |
| 8 | sat. | 80 | 450 | 324 | blocked |
| 9 | not sat. | 40 | 650 | 452 | blocked |
| 10 | sat. | 90 | 324 | 215 | 231 |
| 11 | sat. | 90 | 342 | 232 | 245 |
| 12 | sat. | 80 | 362 | 226 | 329 |

*)sat. = satisfactory

Test series III:

| | | | | Residual |
|---|---|---|---|---|
| Example | TEGO ® | | Web speed | oxygen on |
| UV curing | RC product | Antioxidant | m/min | UV curing |
| 13 | R 902/RC 711 70:30 | 1% | 20 | 200 ppm |
| | | 4,6-bis(octylthiomethyl)-o-cresol | | |
| 14 | RC 902/RC 711 | 1% | 20 | 200 ppm |
| | 70:30 | tributyl phosphite | | |
| 15 | RC 902/RC 711 | 1% | 20 | 200 ppm |
| | 70:30 | tetrakis(2,4-di-t-butylphenyl)4,4-bi- | | |
| | | phenylendiphosphonite | | |
| 16 | RC 902/RC 711 | 1% | 20 | 200 ppm |
| | 70:30 | phenyl diisodecyl phosphite | | |
| 17 | RC 902/RC 711 | 0.1% triphenyl phosphite | 20 | 200 ppm |
| | 70:30 | | | |
| 18 | RC 902/RC 711 | 5% | 20 | 200 ppm |
| | 70:30 | triphenyl phosphite | | |

Performance testing of test series III:

| | | | | Release force | Release force |
|---|---|---|---|---|---|
| | | | Release force | after 24 hours | after 3 months |
| | | Subsequent | after 24 hours | hotmelt | hotmelt |
| | | adhesion | TESA ® 7475 | adhesive tape | adhesive tape |
| Example | Loop test^{*)} | % | cN/2.5 cm | cN/2.5 cm | cN/2.5 cm |

| | | | | | |
|---|---|---|---|---|---|
| 13 | sat. | 80 | 6 | 55 | 61 |
| 14 | sat. | 92 | 7 | 48 | 55 |
| 15 | sat. | 82 | 5 | 51 | 62 |
| 16 | sat. | 93 | 7 | 45 | 52 |
| 17 | sat. | 85 | 7 | 46 | 48 |
| 18 | sat. | 95 | 7 | 43 | 46 |

^{*)}sat. = satisfactory

Test series IV:

| | | | | Residual | |
|---|---|---|---|---|---|
| Example | TEGO ® | | Web speed | oxygen | |
| UV curing | RC product | Antioxidant | m/min | on UV curing | |
| 19 | RC 902/RC 711 | none | 200 | 20 | ppm |
| | 70:30 | | | | |
| 20 | RC 902/RC 711 | none | 200 | 200 | ppm |
| | 70:30 | | | | |
| 21 | RC 902/RC 711 | none | 200 | 500 | ppm |
| | 70:30 | | | | |
| 22 | RC 902/RC 711 | 1% triphenyl phosphite | 200 | 20 | ppm |
| | 70:30 | | | | |
| 23 | RC 902/RC 711 | 1% triphenyl phosphite | 200 | 200 | ppm |
| | 70:30 | | | | |
| 24 | RC 902/RC 711 | 1% triphenyl phosphite | 200 | 500 | ppm |
| | 70:30 | | | | |

Performance testing of test series IV:

| | | | | Release force | Release force |
|---|---|---|---|---|---|
| | | | Release force | after 24 hours | after 3 months |
| | | Subsequent | after 24 hours | hotmelt | hotmelt |
| | | adhesion | TESA ®7475 | adhesive tape | adhesive tape |
| Example | Loop test^{*)} | % | cN/2.5 cm | cN/2.5 cm | cN/2.5 cm |
| 19 | sat. | 92 | 9 | 42 | 49 |
| 20 | not sat. | 60 | 6 | 46 | 85 |
| 21 | not sat. | 42 | 5 | 38 | 224 |
| 22 | sat. | 91 | 8 | 42 | 44 |
| 23 | sat. | 89 | 7 | 44 | 45 |
| 24 | sat. | 78 | 8 | 52 | 63 |

^{*)}sat. = satisfactory

The above description of the invention is intended to be illustrative and not limiting. Various changes or modifications in the embodiments described herein may occur to those skilled in the art. The changes can be made without departure from the scope of the invention.

What is claimed is:

1. A radiation-curable coating composition which comprises at least one radiation-curing organopolysiloxane having (meth)acrylate ester groups, an additive to compensate the inhibition caused by oxygen in the course of curing, and, optionally, photoinitiators, customary auxiliaries and/or adjuvants wherein said additive comprises at least one antioxidant from the group of the phosphorus(III) compounds and/or sulfur compounds.

2. The radiation-curable coating composition as claimed in claim 1, wherein antioxidants are compounds of the general formula
(R)ₐ—P—(OR)_{b}
in which the radicals
R are identical or different and are aliphatic, cycloaliphatic, aromatic, araliphatic or heterocyclic radicals and
a and b can be from 0 to 3, where a+b must be 3.

3. The radiation-curable coating composition as claimed in claim 2, wherein antioxidants are compounds of the general formula
(R)ₐ—P—(OR)_{b}
wherein
R denotes aromatic and/or aliphatic radicals.

4. The radiation-curable coating composition as claimed in claim 2, wherein antioxidants are compounds of the general formula
(R)₂—P—(OR)₁.

5. The radiation-curable coating composition as claimed in claim 2, wherein antioxidants are compounds of the general formula
P—(OR)₃.

6. The radiation-curable coating composition as claimed in claim 1, wherein antioxidants are compounds which have a melting point of below about 80° C.

7. The radiation-curable coating composition as claimed in claim 1, wherein antioxidants are compounds which are liquid at room temperature and are compatible with the silicone matrix.

8. The radiation-curable coating composition as claimed in claim 3, which is a UV curing coating composition.

9. The radiation-curable coating composition according to claim 1, wherein the antioxidant is selected from the group consisting of triphenyl phosphite, diphenyl isodecyl phosphite, diphenyl isooctyl phosphite, phenyl diisodecyl phosphite, triisodecyl phosphite, triisobutyl phosphite, tris(2-ethylhexyl) phosphite, tris(tridecyl) phosphite, trilauryl phosphite, 4,4′-butylidene-bis(3-methyl-6-t-butylphenylditridecyl) phosphite, neopentanetetrayl bis(octadecyl) phosphite, tris(nonylphenyl) phosphite, tris(mono- and/or dinonylphenyl) phosphite, diisodecyl pentaerythritol diphosphite, tetraphenyl dipropylene glycol di-phosphite, poly(dipropylene glycol) phenyl phosphite, alkyl (C₁₀ to C₁₅) bisphenol A phosphite, tris(dipropylene glycol) phosphite, dioleyl hydrogen phosphite, 9,10-dihydro-9-oxa-10-phosphaphenanthrene 10-oxide, 10-(3,5-di-t-butyl)-4-hydroxybenzyl-9,10-dihydro-9-oxa-10-phosphaphenanthrene 10-oxide, 10-decyloxy-9,10-dihydro-9-oxa-10-phospha-phenanthrene, tris(2,4-di-t-butylphenyl) phosphite, cyclic neopentanetetrayl bis(2,4-di-t-butylphenyl) phosphite, cyclic neopentanetetrayl bis(2,6-di-t-butyl-4-methylphenyl) phosphite; 2,2-methylenebis(4,6-di-t-butylphenyl)octyl phosphite, distearyl pentaerythritol diphosphite, di(2,4-di-t-butylphenyl) phosphite, tetrakis(2,4-di-t-butylphenyl)-4,4-biphenylene diphosphonite, bis(2-ethylhexyl) 2-ethylhexylphosphonate, dibutyl butyl phosphonate, triisooctylphosphine, triphenylphosphine, and phenyl-diisooctylphosphine.

10. The radiation-curable coating composition according to claim 1, wherein the antioxidant is selected from the group consisting of dilauryl 3,3′-thiodipropionate, dimyristyl 3,3′-thiodipropionate, distearyl 3,3′-thiodipropionate, 2-mercaptobenzimidazole, n-dodecylthiol, tetrakismethylene-3-(laurylthio)propionatomethane, stearylthiopropylamide, distearyl disulfide, 3,3-thio-di(propionic acid lauryl ester), 3,3-thio-di(propionic acid stearyl ester), di-octadecyl disulfide, thiodiethylene bis[3-(3,5-di-tert-butyl-4-hydroxyphenyl)propionate], 4,6-bis(octylthiomethyl)-o-cresol, 4,4′-thiobis(2-t-butyl-5-methylphenol), 4,4′-thiobis(6-t-butyl-5-methylphenol), and zinc dialkyldithiophosphates.

11. An abhesive coating composition which comprises an adhesive and the radiation-curable coating composition as claimed in claim 1.

12. An article which is coated with the abhesive coating composition according to claim 11.

13. The article according to claim 12, which is a web material.

14. The article according to claim 13 wherein the web material is a plastic, metal or paper.

15. A radiation-curing paint which comprises a pigment and the radiation-curable coating composition according to claim 1.
